(19) United States
(12) Patent Application Publication
(10) Pub. No.: US 2009/0253878 A1
(43) Pub. Date: Oct. 8, 2009

(54) BRANCHED POLYOLEFIN POLYMER TETHERED WITH POLYMERIZABLE METHACRYLOYL GROUPS AND PROCESS FOR PREPARING SAME

(76) Inventors: Zhibin Ye, Sudbury (CA); Jianli Wang, Sudbury (CA); Kejian Zhang, Sudbury (CA)

Correspondence Address: HEENAN BLAIKIE LLP, BAY ADELAIDE CENTRE, 333 BAY STREET, SUITE 2900, P.O. BOX 2900, TORONTO, ON, M5H 2T4, CA

(21) Appl. No.: 12/394,540

(22) Filed: Feb. 27, 2009

Related U.S. Application Data
(60) Provisional application No. 61/032,696, filed on Feb. 29, 2008.

(51) Int. Cl. C08F 22/10; C08F 2/00

(52) U.S. Cl. 526/171; 526/321; 526/319

(57) ABSTRACT

A polyolefin polymer comprising one or more terminal polymerizable methacryloyl groups (i.e. tethered to the main body of the polymer) and a novel process for preparing same are herein disclosed. A hyperbranched polyethylene polymer and a process for preparing same are also disclosed. The polymer is prepared by a novel one-pot copolymerization reaction of an olefin, such as ethylene, and a heterobifunctional comonomer comprising a methacryloyl group, catalyzed by a late transition metal α-diimine catalyst which is selectively non-reactive towards methacryloyl groups. The process allows for preparation of polymers with various chain topologies, including linear, branched, and hyperbranched topologies. The terminal methacryloyl groups within the polymer are reactive in further polymerization reactions. Thus, the polymer may be used in materials and applications which require cross-linking or further polymerization, for example, UV/thermal/radical curable crosslinkers for use in thermoset applications.

### CROSS-REFERENCE TO RELATED APPLICATION

This application claims the benefit under 35 U.S.C. § 1.119(e) of U.S. Provisional Application Ser. No. 61/032,696, filed Feb. 28, 2008, and is incorporated herein by reference.

### FIELD OF THE INVENTION

The present invention relates to a branched polyolefin polymer to which polymerizable methacryloyl groups are tethered, and a process for preparing a polyolefin polymer tethered with polymerizable methacryolyl groups by selective copolymerization.

### BACKGROUND

Distinct from linear polymers, hyperbranched polymers have structures and topologies similar to dendrimers, and possess a number of useful physical properties, such as low solution/melt viscosity, enhanced solubility, abundance in reactive terminal groups, etc¹. Unlike dendrimers that often require tedious synthetic procedures², hyperbranched polymers are more easily produced in large scale, which encourages their use in a wide variety of potential applications, including rheological additives³, toughening agents⁴, drug delivery⁵, etc.

Several hyperbranched polymers functionalized with methacryloyl/acryloyl groups have been reported in the literature⁶⁻¹¹. However, multi-step reactions, along with specially designed monomers, are generally required for synthesis of these uniquely functionalized hyperbranched polymers. Multi-step reactions are undesirable, due to the amount of time and resources required to carry out all the steps in the reaction. Also, there is often a decrease in the yield with each additional step in the reaction pathway, which results in an accumulative decrease in the product yield and efficiency over multi-step processes.

“Chain-walking” olefin polymerization with α-diimine complexes of late transition metals, particularly palladium(II) and nickel(II), has proven to be useful in synthesis strategies for preparing hyperbranched polyolefins including polyethylenes¹². The control of chain topology is achieved uniquely through the chain-walking mechanism of these catalysts while using a simple and commercially abundant monomer, ethylene, as the starting monomer. This is in contrast to the conventional synthetic approaches for hyperbranched polymers, where the hyperbranched topology is usually introduced by using specifically designed functional monomers¹². Moreover, this strategy allows a convenient tuning of polymer chain topology from linear to moderately branched to hyperbranched structure by simple adjustment of the polymerization conditions, such as ethylene pressure and reaction temperature¹²⁻¹³.

Adding polar functional groups to a polymer allows tailoring the physical properties of the resultant polymer, and is thus a desirable feature. However, previously known metallocene catalysts exhibited high oxophilicity (literally, “oxygen loving”), which precluded their use in the copolymerization of polar comonomers¹⁴. Owing to their reduced oxophilicity, palladium(II) and nickel(II) α-diimine catalysts possess tolerance towards polar functional groups, such as ester and halide groups, and thus allow the copolymerization of ethylene with certain polar monomers, typically acrylates and functionalized 1-alkenes bearing polar groups, to prepare hyperbranched polyethylenes tethered with various functionalities¹⁵⁻¹⁸.

Hyperbranched polymers containing a large number of terminal polymerizable double bonds, such as methacryloyl and acryloyl groups, have great potential as high-performance UV/radical curable crosslinkers for use in various composite materials and cross-linkable polymers⁶⁻¹¹. Accordingly, there is a need for alternative processes for preparing hyperbranched polymers that allow introduction of terminal polymerizable double bonds into the polymer.

### SUMMARY OF THE INVENTION

In accordance with a broad aspect of the present invention, there is provided a polyolefin polymer comprising one or more terminal methacryloyl groups, wherein said polymer is a reaction product of an olefin and a bifunctional comonomer, wherein said bifunctional comonomer is of formula (I):

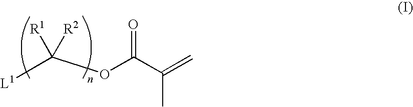

wherein L¹ is selected from the group consisting of

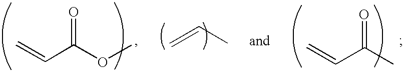

n is an integer selected from 1 to 15; and
R¹ and R² are same or different, and each of R¹ and R² are independently selected from the group consisting of:
   hydrogen, halide, alcohol (—OH),
   C₁-C₆ alkyl optionally substituted with one or more functionalities selected from the group consisting of halide, alcohol (—OH), ester, aldehyde and ketone,
   and C₆-C₁₂ aryl optionally substituted with one or more functionalities selected from the group consisting of alkyl, halide, alcohol (—OH), ester, aldehyde and ketone.

In an embodiment of the invention, the olefin is selected from the group consisting of ethylene, propylene, 1-butene and styrene. Preferably, the olefin is ethylene.

In an embodiment of the invention, a terminus of the polymer is of formula (II):

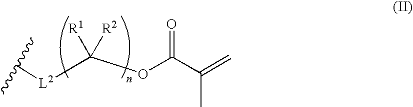

wherein L² is selected from the group consisting of

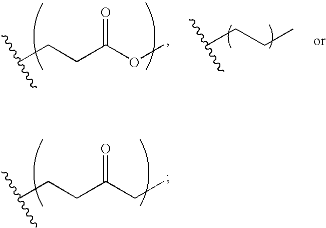

and n, R¹ and R² are as defined above for formula (I).

In another embodiment of the invention, a terminus of the polymer is of formula (III):

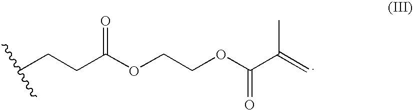

In yet another embodiment of the invention, a terminus of the polymer is of formula (IV):

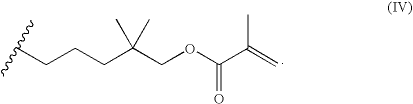

In another embodiment of the invention, the polymer is a reaction product of an olefin and two or more different bifunctional comonomers, wherein each of said bifunctional comonomers is independently selected and is as defined by formula (I).

The polyolefin polymer (“the polymer”) can be linear, branched or hyperbranched. Preferably, the polymer is hyperbranched.

In another broad aspect of the invention, there is provided a process for preparing a polyolefin polymer comprising one or more terminal methacryloyl groups, comprising:
(a) charging a reaction vessel with (i) an olefin, (ii) at least one bifunctional comonomer, wherein said bifunctional comonomer is of formula (I):

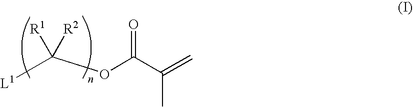

wherein L¹, n, R¹ and R² are as defined above for formula (I), and (iii) optionally, an organic solvent; and
(b) catalyzing a copolymerization reaction with a palladium(II) or nickel(II) α-diimine catalyst to form said polymer.

The olefin may be selected from the group consisting of ethylene, propylene, 1-butene and styrene. In a preferred embodiment, the olefin is ethylene.

The polyolefin polymer (“the polymer”) prepared according to the above-noted process, can be linear or branched in terms of chain topology. Branched chain topologies include all degrees from low levels of branching to hyperbranched. In a preferred embodiment, the polymer prepared by the above-noted process is hyperbranched.

In an embodiment of the invention, the organic solvent is non-polar. Suitable solvents include alkanes, benzene, chlorobenzene, toluene, and halogenated alkanes such as chloroform, carbon tetrachloride and dichloromethane.

In a preferred embodiment, the process utilizes the palladium(II) catalyst, [(ArN═C(Me)-(Me)C═NAr) Pd^{II} (CH₃)(N≡CMe)]⁺SbF₆⁻, wherein Ar is 2,6-(iPr)₂C₆H₃.

In another preferred embodiment of the invention, two or more different bifunctional commoners are used in the above-noted process.

In another preferred embodiment of the process, at least one of the bifunctional comonomers is acryloyloxyethyl methacrylate (AEM). In yet another preferred embodiment of the process, at least one of bifunctional comonomers is 2,2-dimethyl-4-pentenyl methacrylate (DMPM).

In an embodiment of the invention, ethylene pressure is maintained at 1 atm during polymerization. In another embodiment of the invention, polymerization is carried out at ambient temperature.

In another aspect of the present invention, there is provided a use of a palladium(II) α-diimine catalyst or a nickel(II) α-diimine catalyst to prepare a hyperbranched polyolefin polymer tethered with one or more terminal methacryloyl groups. A preferred palladium(II) catalyst for use in preparation of said polymer is [(ArN═C(Me)-(Me)C═NAr)Pd^{II}(CH₃)(N≡CMe)]⁺SbF₆⁻, wherein Ar is 2,6-(iPr)₂C₆H₃.

An aspect of the invention includes a composite material comprising the polyolefin polymer (“the polymer”) described above. Another aspect of the invention includes a UV/thermal/radical crosslinkable material comprising the described polymer.

An advantage of the present invention is that it provides a one-step, single-pot process for preparing hyperbranched polyolefin polymers tethered with terminal polymerizable methacryloyl groups. A further advantage of the present invention is that it is simpler and more efficient than previously known multi-step processes. An additional advantage of the present invention is that it provides a process that may be readily scaled up to an industrial scale.

The polymers as disclosed herein contain terminal polymerizable methacryloyl groups. As such, the polymers of the invention may be used in materials and/or applications that require crosslinking or further polymerization. For example, the polymers of the invention can be used in the formulation of UV/thermal/radical curable crosslinkers which may be used in thermoset applications.

Other and further advantages and features of the invention will be apparent to those skilled in the art from the following detailed description of an embodiment thereof, taken in conjunction with the accompanying drawings.

### BRIEF DESCRIPTION OF THE DRAWINGS

The present invention will be further understood from the following detailed description of an embodiment of the invention, with reference to the drawings in which:

FIG. 1 is a scheme of the structures of heterobifunctional comonomers and synthesis of hyperbranched polyethylene tethered with terminal methacryloyl groups, in accordance with an embodiment of the invention;

FIG. 2 illustrates the ¹H NMR spectra of: (a) a polymer synthesized as described in Run 2 of Table 1, Example 1; (b) a copolymer of ethylene and acryloyloxyethyl methacrylate (AEM) synthesized as described in Run 3 of Table 1, Example 1; (c) the comonomer AEM alone; (d) a copolymer of ethylene and 2,2-dimethyl-4-pentenyl methacrylate (DMPM) synthesized as described in Run 5 of Table 1, Example 1; and (e) the comonomer DMPM alone.

FIG. 3 (a) is a plot of intrinsic viscosity versus molecular weight from gel permeation chromatography with on-line viscometer (GPC-VIS) measurements in tetrahydrofuran (THF) at 30° C. of the polymers synthesized according to Runs 1 to 4 of Table 1, Example 1; and FIG. 3(b) is the polymer melt complex viscosity spectra of the polymers synthesized according to Runs 1, 3 and 4 of Table 1, Example 1, said spectra being obtained at 25° C. from small amplitude dynamic oscillatory measurements.

FIG. 4 illustrates the differential scanning calorimetry (DSC) thermograms of the polymers synthesized according to Runs 2 to 5 of Table 1, Example 1.

### DETAILED DESCRIPTION OF THE INVENTION

Syntheses of functionalized hyperbranched polymers typically require multi-step reactions, along with specially designed monomers. Developing one-step (“one-pot”) synthetic processes for preparing functionalized hyperbranched polymers, using monomers that are readily available, is highly desirable, particularly for industrial-scale processes. Such a one-step process would reduce the overall cost of preparing hyperbranched polymers, as well as having an increased efficiency and yield. Also, a one-step synthetic process would be easier to scale up to industrial-scale process than a multi-step synthetic process.

Utilizing the unique features of chain-walking polymerization, it has now been discovered that a late transition metal α-diimine catalyst can be used for the one-pot synthesis of a novel hyperbranched polyolefin tethered with one or more methacryloyl groups by selective copolymerization of the olefin with a heterobifunctional polar comonomer which has a methacryloyl group as one of its functionalities. The methacryloyl group(s) are located at the terminus of one or more branches of the hyperbranched polymer, and as such are viewed as “tethered” to the main body of the polymer. The terminal methacryloyl groups have double bonds which are polymerizable and are thus reactive in further polymerization reactions, so that the hyperbranched polymer may be used in applications which require cross-linking or further polymerization.

Preferred late transition metals in the catalyst used in the process are palladium(II) (Pd^{II}) and nickel(II) (Ni^{II}). Pd^{II} α-diimine catalysts are particularly preferred.

This unique one-step synthetic chemistry is based on the unexpected finding that although a Pd^{II} α-diimine catalyst is successful in copolymerizing acrylates and 1-alkenes, it cannot copolymerize methacrylate type comonomers. Due to their similar catalytic activity to Pd^{II} α-diimine catalysts, Ni^{II} α-diimine catalysts are also expected to be non-reactive towards methacryloyl groups.

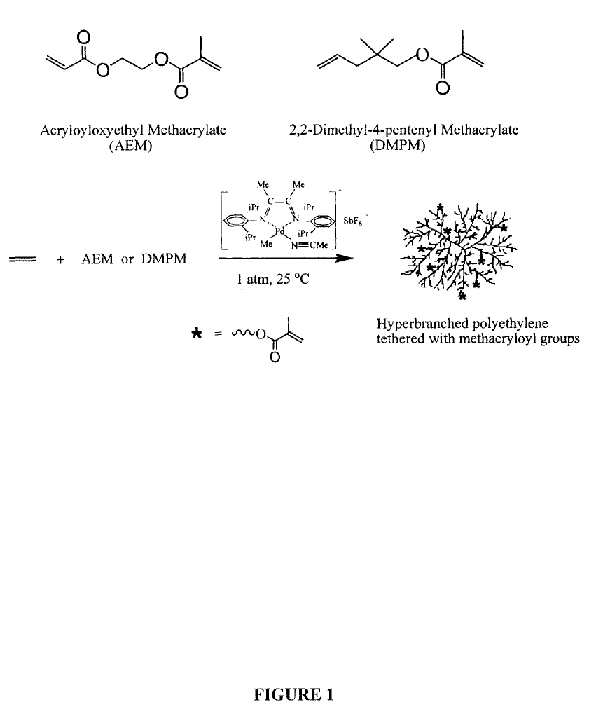

In a preferred embodiment of the invention, a hyperbranched polyethylene polymer tethered with terminal methacryloyl groups is prepared from ethylene and acryloyloxyethyl methacrylate (AEM) by chain-walking polymerization catalyzed by a Pd^{II} α-diimine catalyst (FIG. 1). In another preferred embodiment of the invention, a hyperbranched polymer tethered with terminal methacryloyl groups is prepared from ethylene and 2,2-dimethyl-4-pentenyl methacrylate (DMPM) catalyzed by a Pd^{II} α-diimine catalyst (also shown in FIG. 1). In yet another preferred embodiment, the Pd^{II} α-diimine catalyst used for the chain-walking polymerization reaction is [(ArN═C(Me)-(Me)C═NAr) Pd^{II} (CH₃)(N≡CMe)]⁺SbF₆⁻, wherein Ar=2,6-(iPr)₂C₆H₃.

Both monomers, AEM and DMPM, contain one copolymerizable group (acryloyl and 1-alkenyl, respectively) and one methacryloyl moiety which is non-copolymerizable by the late transition metal (Pd^{II} or Ni^{II}) α-diimine catalyst. Owing to the selectivity of the catalyst toward the acryloyl or 1-alkenyl groups in the two heterobifunctional comonomers, hyperbranched polyolefins tethered with methacryloyl end groups result from the enchainment of the acryloyl or 1-alkenyl groups (FIG. 1).

In the functionalized hyperbranched polymers produced, intra- or intermolecular crosslinking should be absent owing to the complete incopolymerizability of the methacryloyl groups in chain-walking copolymerization. However, crosslinking might occur due to thermally initiated radical polymerization among the pendant methacryloyl groups. In designing the 1-alkenyl type heterobifunctional monomer, DMPM, a quaternary “blocking” carbon was introduced between the 1-alkenyl and the methacryloyl groups to block the Pd^{II} catalyst from walking to the carbon next to the methacryloyl group during chain growth, which can possibly deactivate the catalyst^{15a}.

In a preferred embodiment of the invention, the polymerization reaction was allowed to progress for about 24 hours before terminating the reaction. Reaction time may be more or less, depending on the degree of polymerization desired. The polymerization reaction may be terminated by removing one or more of the comonomer reactants. For example, if ethylene gas is used, the reaction vessel can be vented to remove ethylene. The reaction may also be terminated by addition of a catalyst poison that significantly reduces the reactivity of the catalyst so that it can no longer catalyze the polymerization reaction. Catalyst poisons that are well-known in the art include triethylsilane and acidified methanol.

In an embodiment of the invention, ethylene may be provided in gaseous or in liquid form for the polymerization reaction.

In another embodiment of the invention, ethylene is copolymerized with two or more different heterobifunctional comonomers, wherein each of said comonomers comprises a methacryloyl group.

An organic solvent may be present in the reaction vessel to solubilize the comonomers and the catalyst. In an embodiment of the invention, a non-polar organic solvent is used. Suitable non-polar solvents include alkanes, benzene, chlorobenzene, toluene, and halogenated alkanes such as chloroform, carbon tetrachloride and dichloromethane.

In a preferred embodiment, the polymerization reaction is carried out with ethylene pressure of 1 atm and at ambient temperature. Ambient temperature is understood to be room temperature, i.e. without the addition of heat, or around 25° C. The reduced ethylene pressure was chosen with the purpose of generating hyperbranched chain topology¹³. Ambient temperature was selected to minimize the possible thermal initiated radical cross-linking among the methacryloyl groups at elevated temperatures. For AEM, two levels of comonomer concentration were chosen. Table 1 in Example 1 summarizes the polymerization conditions and results.

The hyperbranched polymers of the invention may be used in alone or in the preparation of composite materials. The hyperbranched polymers and composite materials comprising the hyperbranched polyethylenes can be used in high-performance materials and other applications for which such functionalized polyolefin polymers are known to be useful. For example, these functionalized hyperbranched polymers exhibit low viscosity and have significant potential in applications wherein a cross-linkable polymer is required, e.g. an inkjet printable UV-curable macro-crosslinker.

Further details of the preferred embodiments of the invention are illustrated in the following Examples which are understood to be non-limiting with respect to the appended claims.

### Example 1

### Preparation of Hyperbranched Polyethylene Polymers Tethered with Terminal Methacryoyl Groups

Polymerization reactions Runs 1 to 5 were carried out as noted below in (a) to (e), each in the presence of the Pd^{II} α-diimine catalyst, [(ArN═C(Me)-(Me)C═NAr) Pd^{II} (CH₃)(N≡CMe)]⁺SbF₆⁻, wherein Ar=2,6-(iPr)₂C₆H₃.

In each run, the polymerization reaction was carried out in a 500 mL jacketed glass reactor equipped with a magnetic stirrer, under 1 atm ethylene pressure. In each run, the jacketed glass reactor was first oven-dried, subsequently purged at least three times with ethylene, and then pressurized with 1 atm ethylene. Gaseous ethylene was used in the following examples but liquid ethylene may also be used.

A prescribed amount of anhydrous CH₂Cl₂ was added into the reactor. A prescribed amount of a given comonomer, methyl methacrylate (MMA), acryloyloxyethyl methacrylate (AEM) or 2,2-dimethyl-4-pentenyl methacrylate (DMPM), was added in each of Runs 2 to 5 to a final given concentration as noted below.

The reactor temperature was maintained by passing a water/ethylene glycol mixture through the jacket using a circulating bath set at the desired polymerization temperature.

After thermal equilibrium, 10 mL of the catalyst solution containing 0.1 mmol Pd^{II} α-diimine catalyst in CH₂Cl₂ was injected into the reactor to start the polymerization reaction. Total volume of CH₂Cl₂ in the reactor was 50 mL. After around 24 hours, the polymerization reaction was terminated by venting the reactor.

The solvent was subsequently evaporated to recover the polymer product (observed as an oily product). To remove the catalyst residue remaining in the polymer, the oily polymer product was re-dissolved in petroleum ether and the solution was passed through a short column packed with neutral alumina and silica gel. The purified polymer was then recovered by precipitation in acetone. It was dried overnight under vacuum at room temperature and then weighed before analysis.

### (a) Run 1: Ethylene Alone

As a control, ethylene (1 atm) was polymerized alone, i.e. without the addition of any other comonomer, using the Pd^{II} α-diimine catalyst noted above, at 25° C.

(b) Run 2: Ethylene+methyl methacrylate (0.6 M)

Ethylene (1 atm) and methyl methacrylate (MMA) (0.6 M) were polymerized using the Pd^{II} α-diimine catalyst noted above, at 25° C.

(c) Run 3: Ethylene+acryloyloxyethyl methacrylate (AEM), 0.1 M

Ethylene (1 atm) and acryloyloxyethyl methacrylate (0.1 M) were polymerized in the presence of Pd^{II} α-diimine catalyst noted above, at 25° C. (see Run 3 in Table 1).

(d) Run 4: Ethylene+acryloyloxyethyl methacrylate (AEM), 1.0 M

Ethylene (1 atm) and acryloyloxyethyl methacrylate (1.0 M) were polymerized in the presence of Pd^{II} α-diimine catalyst noted above, at 25° C.

(e) Run 5: Ethylene+2,2-dimethyl-4-pentenyl methacrylate (DMPM), 0.15 M

Ethylene (1 atm) and 2,2-dimethyl-4-pentenyl methacrylate (DMPM) (1.0 M) were polymerized in the presence of Pd^{II} α-diimine catalyst noted above, at 25° C.

The results of the copolymerization reactions noted above are summarized in Table 1 below.

TABLE 1
Polymerization conditions and results, and polymer properties

| | | Polymer | Comonomer | GPC-VIS | | Branching | Thermal | |
|---|---|---|---|---|---|---|---|---|
| | Comonomer, | amount | incorporation | Mₙ | | density ^{d} | transitions ^{e} | |
| Run | concentration ^{a} | (g) | (mol %) ^{b} | (kg/mol) | PDI | (per 1000 C.) | T_{g} | Tₘ |
| 1 | n/a | 9.8 | — | 118 | 1.70 | 102 | −67.5° C. | −34.3° C. |
| 2 | MMA, 0.6M | 11.2 | 0 | 118 | 1.66 | 100 | −67.5° C. | −34.5° C. |
| 3 | AEM, 0.1 M | 3.3 | 0.2 | 63 | 1.74 | 102 | −68.6° C. | −35.1° C. |
| 4 | AEM, 1.0 M | 2.2 | 3.6 | 62 | 1.47 | 90 | −64.3° C. | −35.1° C. |
| 5 | DMPM, 0.15 M | 6.0 | 0.6 | 5.2 | 3.47 | 106 | −71.2° C. | −39.1° C. |

^{a} Other conditions: Pd^{II} α-diimine catalyst, 0.1 mmol; Solvent, CH₂Cl₂ total volume, 50 mL; temperature, 25° C.; ethylene, 1 atm; polymerization time, 24 hr.
^{b} Comonomer percentage in the copolymers determined using ¹H NMR in CDCl₃ at room temperature. Number-average molecular weight (Mₙ) and polydispersity index (PDI) determined using gel permeation chromatography with on-line viscometer (GPC-VIS).
^{d} Branching density determined using ¹H NMR.
^{e} Two heating scans were conducted in each DSC measurement, with a cooling scan prior to the second heating scan. Thermal transition temperatures were determined in the second heating scan at 10° C./minute.

### Example 2

### Analysis of Hyperbranched Polymers

### (a) ¹H NMR Spectra

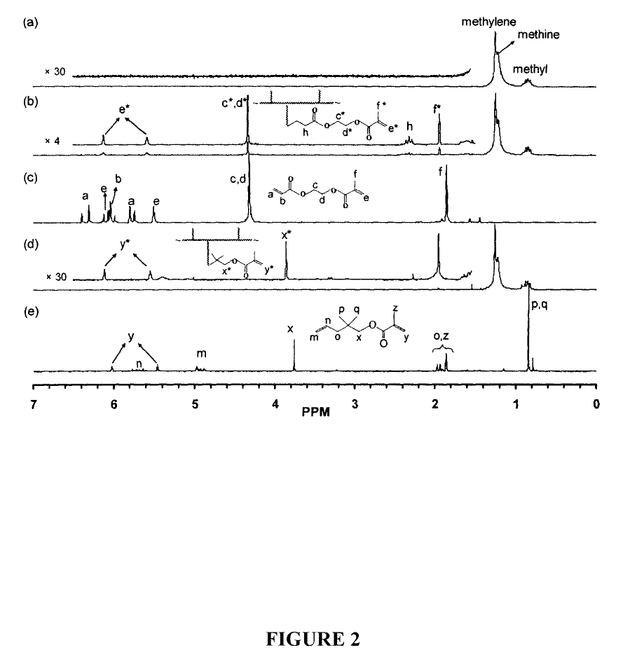

FIG. 2(a) shows the proton nuclear magnetic resonance (¹H NMR) spectrum of the polymer produced in the presence of MMA. The spectrum is identical to that of homopolyethylene with only methyl, methylene, and methine resonances from the hyperbranched polyethylene sequences in the narrow region from 0.6 to 1.5 ppm^{17,18}. No resonance peak due to the incorporation of MMA was found. Thus, it was concluded that MMA was not copolymerized even at a high concentration of 0.6 M. From the polymer productivity data shown in Table 1, the presence of MMA did not appear to inhibit the polymerization with a similar quantity of polymer produced compared to the control run. This was drastically different from the copolymerization of ethylene with copolymerizable acrylate and 1-alkene comonomers, where comonomer incorporation often leads to significant reduction in polymerization activity as well as the polymer molecular weight^{15b, 16a}.

As noted in Table 1, the two polymers have almost identical number-average molecular weight (Mₙ) and polydispersity index (PDI) data determined by using gel permeation chromatography with on-line viscometer (GPC-VIS). With these results, it was concluded that the polymer synthesized in the presence of MMA was essentially an ethylene homopolymer, and methacrylate comonomers cannot be copolymerized with ethylene by chain-walking polymerization with the Pd^{II} α-diimine catalyst. Thus, it appears that methacrylates are inaccessible to copolymerization with ethylene by late transition metal α-diimine catalysts, including Pd^{II} α-diimine catalysts. It is possible that methacrylate is an unfavourable substrate to the catalyst due to the sterically bulkier structure of the 1′-disubstituted monomer.

¹H NMR elucidation of the copolymer microstructures confirms the selective incorporation of both AEM and DMPM in the hyperbranched copolymers through the sole enchainment of the acryloyl and 1-alkenyl groups, respectively. FIG. 2(b) shows the ¹H NMR spectrum of the copolymer synthesized in Run 4 (with AEM at 1.0 M) and FIG. 2(c) shows the spectrum of AEM for comparison. In FIG. 2(b), the incorporation of AEM and the presence of methacrylate groups in the copolymer can be evidenced from the signals of the double bond protons (e* at 6.12 and 5.58 ppm), the signal of the methyl protons on the methacryloyl group (f* at 1.94 ppm), and the signals of the methylene groups between the two ester functionalities (c*, d* at 4.31 ppm). On the contrary, the signals attributable to the acrylate groups are not found. This corroborates that AEM is incorporated through enchainment of acryloyl groups and methacryloyl functionalities are intact. In addition, a new triplet signal (h) located at 2.31 ppm, not found in the comonomer, is observed in FIG. 2(b). This triplet resonance is assigned to the methylene protons of the incorporated acryloyl group, whose structure is shown in FIG. 2(b). Such a unique microstructure has been typically observed in olefin-acrylate copolymers prepared using Pd^{II} α-diimine catalysts^{15a, 15b, 17, 18}. The mechanism leading to this microstructure has been elucidated clearly in the reports by Brookhart et al^{15a15b}. It is a consequence of the 2,1-insertion of acrylate comonomer into the Pd^{II}-polymer bond followed by rearrangement leading to the formation of a 6-member stable chelate structure available for subsequent ethylene insertion^{15a,15b}.

FIG. 2(d) shows the ¹H NMR spectrum of the copolymer synthesized in Run 5 (with DMPM at 0.15 M) and FIG. 2(e) shows that of DMPM comonomer. The incorporation of DMPM and the tethering of methacryloyl groups in the copolymer were evidenced based on the signals x* and y* shown in FIG. 1(d). Similarly, the 1-alkenyl groups were not observed, showing the comonomer incorporation occurred through sole enchainment of the 1-alkenyl groups.

The comonomer molar percentages in the three copolymers were calculated based on their ¹H NMR spectra. Table 1 lists the calculation results. Comparing Runs 3 and 4, increasing AEM concentration from 0.1 M to 1.0 M during polymerization led to an increase in comonomer molar percentage from 0.2 to 3.6%, and a decrease in both polymer productivity and polymer molecular weight, which are consistent with the literature results on ethylene copolymerization with methyl acrylate^{15a,15b}. The branching densities of these hyperbranched polymers (listed in Table 1), resulting from chain walking of the Pd^{II} α-diimine catalyst, were determined based on the methyl, methine, and methylene signals of the ethylene sequences in the ¹H NMR spectra.

### (b) Differential Scanning Calorimetry (DSC)

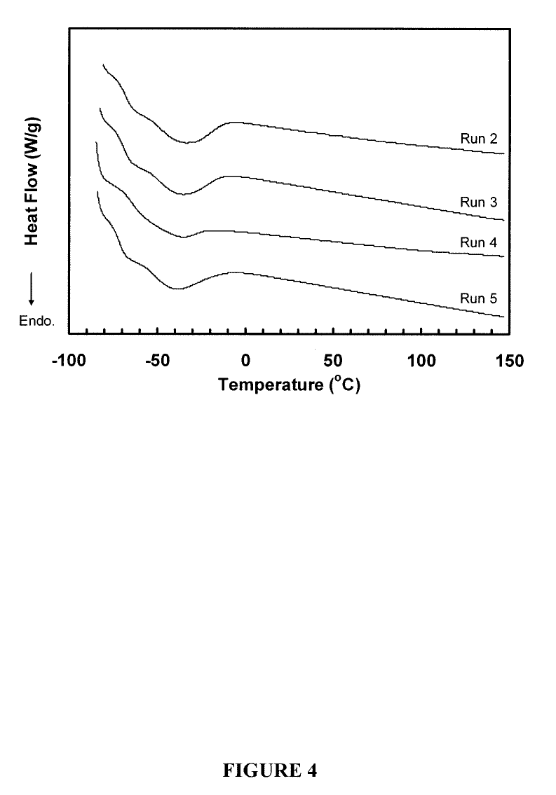

The polymers were subjected to thermal analysis, using differential scanning calorimetry (DSC). The DSC thermograms of the polymers prepared in Runs 2 to 5 are shown in FIG. 4.

Like the homopolymers synthesized in Runs 1 and 2, the copolymers obtained in Runs 3 to 5 are completely amorphous oil-like materials at room temperature. DSC measurements showed that the copolymers prepared in Runs 1 to 5 exhibit similar thermal behaviors with a glass transition temperature (T_{g}) at about −67° C. and a very weak endotherm (possibly a melting endotherm, nominally denoted as “Tₘ”) centered at about −35° C. (see Table 1 and FIG. 4). The comonomer incorporation did not appear to introduce other thermal transitions.

The incorporation of AEM slightly increases the value of T_{g} (see copolymer in Run 4), while DMPM incorporation seems to slightly reduce the value of T_{g}. In the first heating scan during DSC measurement, a broad exothermic peak centered at about 130° C. was observed with the AEM copolymer synthesized in Run 4, indicating the exothermic polymerization of the pendant methacryloyl groups in this polymer having the highest content of methacryloyl groups. In the subsequent (second and third) heating scans, no exotherm was found, indicating the polymerization was complete in the first heating scan. Such an exothermic peak was not detected in other two copolymers, due to the low contents of methacryloyl groups.

(c) Gel Permeation Chromatography with On-Line Viscometer (GPC-VIS)

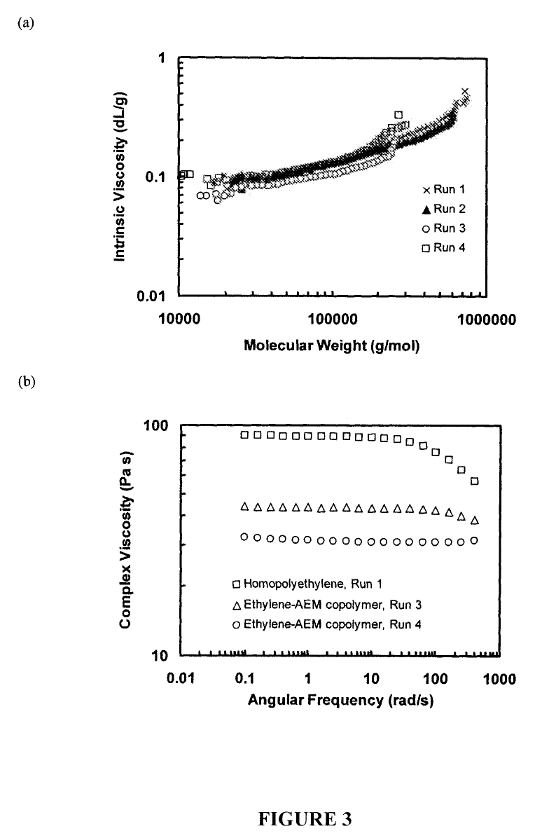

FIG. 3(a) compares the Mark-Houwink plot (intrinsic viscosity vs molecular weight) of the four polymers synthesized in Runs 1 to 4, obtained from GPC-VIS measurements. A very similar and weak dependency of intrinsic viscosity on polymer molecular weight was observed, indicating the similar hyperbranched chain topology possessed in these polymers. The incorporation of small sized comonomer does not seem to significantly affect the chain topology of the copolymers¹⁸. This is different from the copolymers of ethylene with acryloyl-POSS (polyhedral oligomeric silsesquioxane) macromonomer, where significant reductions in the intrinsic viscosity of the copolymers occurs owing to the covalent tethering of highly compact POSS nanospheres of high mass density¹⁷. FIG. 3(b) compares the complex viscosity spectra obtained at 25° C. for the three polymers synthesized in Runs 1, 3, and 4, respectively. The homopolyethylene synthesized in Run 1 possesses a low Newtonian viscosity of 89 Pa s at 25° C. and exhibits shear thinning at the high frequency end. The two ethylene-AEM copolymers possess even reduced Newtonian viscosity (43 and 31 Pa s, respectively) and do not show obvious shear thinning behavior due to their reduced molecular weight.

Numerous modifications, variations and adaptations may be made to the particular embodiments of the invention described above without departing from the scope of the invention, which is defined in the following claims.

### REFERENCES

1. (a) Gao, C.; Yan, D. Prog. Polym. Sci. 2004, 29, 183. (b) Voit, B. J. Polym. Sci., Part A. Polym. Chem. 2000, 38, 2505.
2. Grayson, S. M.; Frechet, J. M. J. Chem. Rev. 2001, 10, 3819.
3. (a) Hong, Y.; Cooper-White, J. J.; Mackay, M. E.; Hawker, C. J.; Malmstrom, E.; Rehnberg, N. J. Rheol. 1999, 43, 781. (b) Wang, J.; Ye, Z.; Zhu, S. Ind. Eng. Chem. Res. 2007, 46, 1174. (c) Wang, J.; Kontopoulou, M.; Ye, Z.; Subramanian, R.; Zhu, S. J. Rheol. 2008, 52, 243.
4. (a) Varley, R. J. Polym. Int. 2004, 53, 78. (b) Karger-Kocsis, J.; Fröhlich, J.; Gryshchuk, O.; Kautz, H.; Frey, H.; Mulhaupt, R. Polymer 2004, 45, 1185.
5. (a) Gao, C.; Xu, Y.; Yan, D.; Chen, W. Biomacromolecules 2003, 4, 704. (b) Kolhe, P.; Misra, E.; Kannan, R. M.; Kannan, S.; Lieh-Lai, M. Int. J. Pharm. 2003, 259, 143.
6. Johansson, M.; Glauser, T.; Rospo, G.; Hult, A. J. Appl. Polym. Sci. 2000, 75, 612.
7. Wei, H.; Lu, Y.; Shi, W.; Yuan, H.; Chen, Y. J. Appl. Polym. Sci. 2001, 80, 51.
8. Zhu, S.-W.; Shi, W.-F. Polym. Degrad. Stabil. 2002, 75, 543.
9. (a) Wan, Q.; Schricker, S. R.; Culbertson, B. M. J. Macromol. Sci., Part A. Pure Appl. Chem. 2000, 37, 1301. (b) Wan, Q.; Schricker, S. R.; Culbertson, B. M. I Macromol Sci., Part A: Pure Appl. Chem. 2000, 37, 1317.
10. Liu, H.; Wilén, C.-E. J Polym. Sci., Part A: Polym. Chem. 2001, 39, 964.
11. Maruyama, K.; Kudo, H.; Ikehara, T.; Nishikubo, T.; Nishimura, I.; Shishido, A.; Ikeda, T. Macromolecules 2007, 40, 4895.
12. (a) Guan, Z.; Cotts, P. M.; McCord, E. F.; McLain, S. J. Science 1999, 283, 2059. (b) Cotts, P. M.; Guan, Z.; McCord, E.; McLain, S. Macromolecules 2000, 33, 6945. (c) Guan, Z. Chem. Eur. J. 2002, 8, 3086.
13. (a) Ye, Z.; Zhu, S. Macromolecules 2003, 36, 2194. (b) Ye, Z.; AlObaidj, F.; Zhu, S. Macromol. Chem. Phys. 2004, 205, 897.
14. Boffa, L. S.; Novak, B. M. Chem. Rev. 2000, 100, 1479-1494
15. (a) Johnson, L. K.; Mecking, S.; Brookhart, M. J. Am. Chem. Soc. 1996, 118, 267. (b) Mecking, S.; Johnson, L. K.; Wang, L.; Brookhart, M. J. Am. Chem. Soc. 1998, 120, 888. (c) Ittel, S. D.; Johnson, L. K.; Brookhart, M. Chem. Rev. 2000, 100, 1169.
16. (a) Chen, G.; Ma, X. S.; Guan, Z. J. Am. Chem. Soc. 2003, 125, 6697. (b) Chen, G.; Huynh, D.; FeIgner, P. L.; Guan, Z. J. Am. Chem. Soc. 2006, 128, 4298.
17. Wang, J.; Ye, Z.; Joly, H. Macromolecules 2007, 40, 6150.
18. Zhang, K.; Wang, J.; Subramanian, R.; Ye, Z.; Lu, J.; Yu, Q.; Macromol. Rapid Commun. 2007, 28, 2185.

We claim:

1. A polyolefin polymer comprising one or more terminal methacryloyl groups, wherein said polymer is a reaction product of an olefin and a bifunctional comonomer, wherein said bifunctional comonomer is of formula (I): 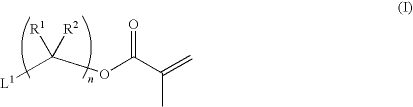
wherein L¹ is selected from the group consisting of 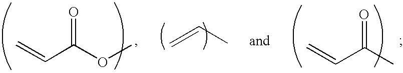
n is an integer selected from 1 to 15; and
R¹ and R² are same or different, and each of R¹ and R² are independently selected from the group consisting of:
hydrogen, halide, alcohol (—OH),
C₁-C₆ alkyl optionally substituted with one or more functionalities selected from the group consisting of halide, alcohol (—OH), ester, aldehyde and ketone,
and C₆-C₁₂ aryl optionally substituted with one or more functionalities selected from the group consisting of alkyl, halide, alcohol (—OH), ester, aldehyde and ketone.

2. The polymer of claim 1, wherein a terminus of said polymer is of formula (II): 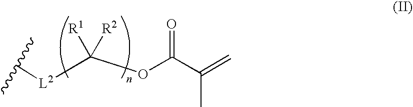
wherein L² is 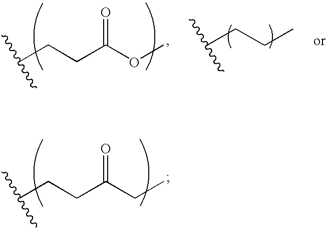
n is an integer selected from 1 to 15;
R¹ and R² are same or different, and each of R¹ and R² are independently selected from the group consisting of:
hydrogen,
C₁-C₆ alkyl optionally substituted with one or more functionalities selected from the group consisting of halide, alcohol (—OH), ester, aldehyde and ketone,
and C₆-C₁₂ aryl optionally substituted with one or more functionalities selected from the group consisting of alkyl, halide, alcohol (—OH), ester, aldehyde and ketone.

3. The polymer of claim 1 wherein a terminus of said polymer is of formula (III):

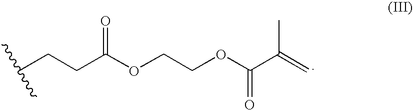

4. The polymer of claim 1, wherein a terminus of said polymer is of formula (IV):

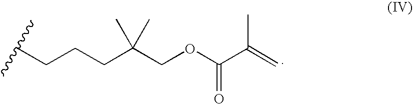

5. The polymer of claim 1, wherein said polymer is a reaction product of an olefin and two or more different bifunctional comonomers, wherein each of said bifunctional comonomers is independently selected and is as defined in formula (I).

6. The polymer of claim 1, wherein said olefin is selected from the group consisting of ethylene, propylene, 1-butene and styrene.

7. The polymer of claim 1, wherein said polymer is linear, branched or hyperbranched.

8. A process for preparing a polyolefin polymer comprising one or more terminal methacryloyl group(s), comprising:
(a) charging a reaction vessel with (i) optionally, an organic solvent, (ii) an olefin, and (iii) at least one bifunctional comonomer, wherein said bifunctional comonomer is of formula (I): 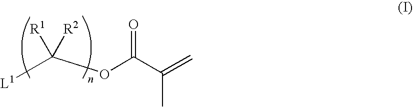
wherein L¹ is 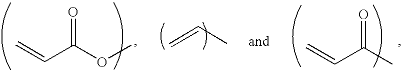
n is an integer selected from 1 to 15;
R¹ and R² are same or different, and each of R¹ and R² are independently selected from the group consisting of:
hydrogen, halide, alcohol (—OH),
C₁-C₆ alkyl optionally substituted with one or more functionalities selected from the group consisting of halide, alcohol (—OH), ester, aldehyde and ketone,
and C₆-C₁₂ aryl optionally substituted with one or more functionalities selected from the group consisting of alkyl, halide, alcohol (—OH), ester, aldehyde and ketone; and
(b) catalyzing a copolymerization reaction with a palladium(II) α-diimine catalyst or a nickel(II) α-diimine catalyst to form said polymer.

9. The process of claim 8, wherein said olefin is selected from the group consisting of ethylene, propylene, 1-butene and styrene.

10. The process of claim 9, wherein pressure is maintained at 1 atm during copolymerization.

11. The process of claim 8, wherein said polymer is linear, branched or hyperbranched.

12. The process of claim 8 wherein the catalyst is
[(ArN═C(Me)-(Me)C═NAr)Pd^{II}(CH₃)(N≡CMe)]⁺SbF₆⁻
wherein Ar is 2,6-(iPr)₂C₆H₃.

13. The process of claim 8 wherein two or more different bifunctional commoners are charged into said reaction vessel, and wherein each of said bifunctional commoners is independently selected and is as defined in formula (I).

14. The process of claim 8 wherein the at least one bifunctional comonomer is selected from the group consisting of acryloyloxyethyl methacrylate (AEM) and 2,2-dimethyl-4-pentenyl methacrylate (DMPM).

15. The process of claim 8 wherein said organic solvent is non-polar.

16. The process of claim 15, wherein said organic solvent is selected from the group consisting of alkanes, benzene, chlorobenzene, toluene, chloroform, carbon tetrachloride and dichloromethane.

17. The process of claim 8 wherein the copolymerization reaction is carried out at ambient temperature or higher.

18. The process of claim 8 wherein the copolymerization reaction is allowed to progress for around 24 hours.

19. The polymer as prepared by the process of claim 8.

20. Use of a palladium(II) α-diimine catalyst or a nickel(II) α-diimine catalyst to prepare a polyolefin polymer comprising one or more terminal methacryloyl groups.

21. The use according to claim 20, wherein a constituent olefin of said polyolefin polymer is selected from the group consisting of ethylene, propylene, 1-butene and styrene.

22. The use according to claim 20 wherein said polymer is linear, branched or hyperbranched.

23. The use according to claim 20 to prepare the polymer of claim 1.

24. The use according to claim 20, wherein said palladium(II) α-diimine catalyst is [(ArN═C(Me)-(Me)C═NAr) Pd^{II}(CH₃)(N≡CMe)]⁺SbF₆⁻, wherein Ar is 2,6-(iPr)₂C₆H₃.
